(19) United States
(12) Patent Application Publication
(10) Pub. No.: US 2009/0037466 A1
(43) Pub. Date: Feb. 5, 2009

(54) METHOD AND SYSTEM FOR RESOLVING FEATURE DEPENDENCIES OF AN INTEGRATED DEVELOPMENT ENVIRONMENT WITH EXTENSIBLE PLUG-IN FEATURES

(76) Inventors: Micah M. Cross, Creedmoor, NC (US); Shelley Yang, Chapel Hill, NC (US)

Correspondence Address: DILLON & YUDELL LLP, 8911 N. CAPITAL OF TEXAS HWY., SUITE 2110, AUSTIN, TX, 78759, US

(21) Appl. No.: 11/831,637

(22) Filed: Jul. 31, 2007

(51) Int. Cl. G06F 17/30

(52) U.S. Cl. 707/104.1; 707/E17.005

(57) ABSTRACT

A method, system and computer-readable medium for an enhanced dependency resolver are disclosed. The dependency resolver collects dependency information for features of a rich client platform from a plurality of update sites; stores the dependency information for the features in a database; constructs a plurality of dependency trees using the dependency information of the database, wherein each of the plurality of dependency trees is rooted by a node representing an installable feature; selects an installable feature; identifies all nodes of a dependency tree rooted by the installable feature; determines which of the nodes require an adjacent node. If the node requires an adjacent node, the dependency resolver climbs the include tree of the adjacent node until a node of a second installable feature is found and records in the database that the second installable feature is required for the installation of the other installable feature.

### BACKGROUND OF THE INVENTION

The present invention relates in general to the field of computers and computer systems, and in particular to a rich client platform with extensible plug-in features.

A rich client platform (RCP) is a computer program product that provides software developers a set of tools to assist in developing computer software. Typical RCPs (e.g., Eclipse) include a core platform (main boot program and plug-ins), a standard bundling framework (e.g. OSGi bundles), a portable widget toolkit, a user-interface toolkit (providing file buffers, text handling and text editors), a workbench and a dependency resolver (e.g., Eclipse Resolver).

RCPs, such as Eclipse, employ installable features and plug-ins in order to provide functionality on top of (and included in) the rich client platform, in contrast to some other applications where functionality is hard-coded. Plug-ins are often implemented as software bundles (e.g., OSGi bundles). Installable features and plug-ins typically have dependencies on other features and plug-ins, and on particular versions of other features and plug-ins. An RCP such as Eclipse may employ many such features and plug-ins, creating a complicated web of dependencies of which a user must keep track.

Dependency resolvers assist users in locating feature and plug-in updates from remote update sites. Each update site typically specifies which features are installable (external features) in an extensible markup language (XML) file (e.g., “site.xml”). The dependencies of features and plug-ins are typically described in XML files (e.g., “feature.xml”, “plugin.xml”) as well. Dependency resolvers, such as the standard Eclipse Resolver, only resolve dependencies for a single site. But it is often the case that certain features and plug-ins are dependent upon other features or plug-ins which are not available on the same update site. It is therefore desired to have an dependency resolver that can resolve dependencies across multiple update sites.

### BRIEF SUMMARY OF THE INVENTION

The present invention provides a method, system and computer program product for providing an enhanced dependency resolver for a rich client platform. In one embodiment, the dependency resolver collects dependency information for features and plug-ins of a rich client platform from a plurality of update sites; stores the dependency information for the features and plug-ins in a database; constructs a plurality of dependency trees using the dependency information of the database, wherein each of the plurality of dependency trees is rooted by a node representing an installable feature; selects an installable feature; identifies all nodes of a dependency tree rooted by the installable feature; determines which of the nodes require an adjacent node. If the node requires an adjacent node, the dependency resolver climbs the include tree of the adjacent node until a node of a second installable feature is found and records in the database that the second installable feature is required for the installation of the other installable feature.

The above, as well as additional purposes, features, and advantages of the present invention will become apparent in the following detailed written description.

### BRIEF DESCRIPTION OF THE SEVERAL VIEWS OF THE DRAWINGS

The novel features believed characteristic of the invention are set forth in the appended claims. The invention itself, however, as well as a best mode of use, farther purposes and advantages thereof, will best be understood by reference to the following detailed description of an illustrative embodiment when read in conjunction with the accompanying drawings, where:

FIG. 1 is a block diagram of an exemplary data processing system in which the present invention may be implemented;

FIG. 2 is a diagram that depicts an exemplary software framework and the dependencies between features, external features and plug-ins;

FIG. 3 is a flowchart depicting an exemplary method for providing a dependency resolving program in accordance with one or more embodiments of the present invention;

### DETAILED DESCRIPTION OF THE INVENTION

An illustrative embodiment of the present invention is directed to a method, system and computer program product for resolving dependencies within a software framework of a data processing system. The present invention can take the form of an entirely hardware embodiment, an entirely software embodiment or an embodiment containing both hardware and software elements. In an illustrative embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus or device.

The medium can be an electronic, magnetic, optical, electromagnetic, infrared or semiconductor system, apparatus or device or a propagation medium. Examples of a computer-readable medium include a semiconductor or solid state memory (e.g., flash drive memory), magnetic tape, a removable computer diskette, a random access memory (RAM), a read-only memory (ROM), a rigid magnetic disk (e.g., a hard drive) and an optical disk. Current examples of optical disks include compact disk-read only memory (CD-ROM), compact disk-read/write (CD-R/W) and Digital Versatile Disk (DVD).

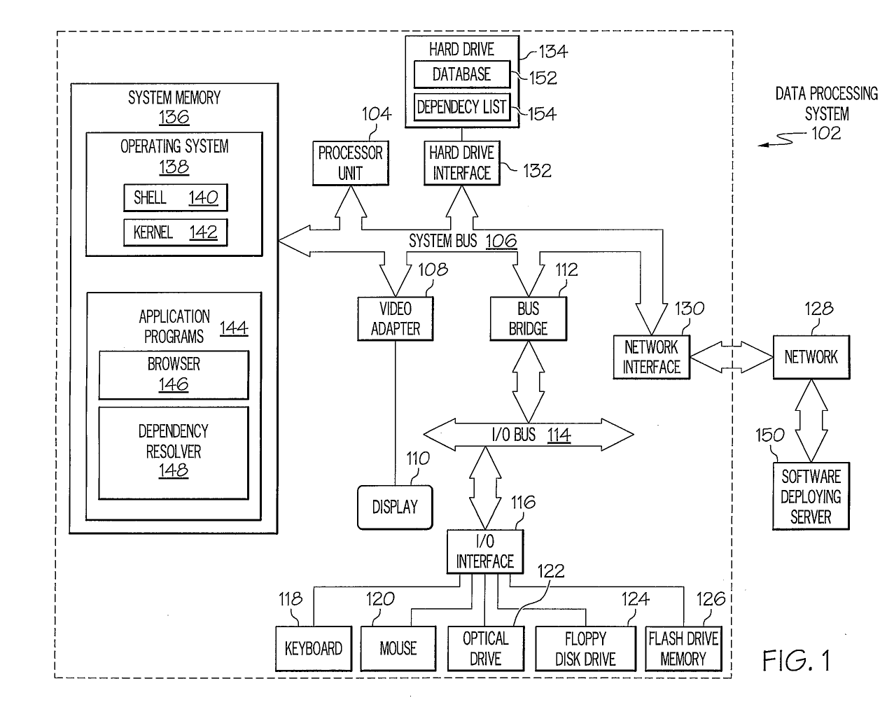

Referring now to the drawings, wherein like numbers denote like parts throughout the several views, FIG. 1 shows a block diagram of a data processing system suitable for storing and/or executing program code in accordance with one or more embodiments of the present invention. The hardware elements depicted in data processing system 102 are not intended to be exhaustive, but rather are representative of one embodiment of the present invention. Data processing system 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, an optical disk drive 122, a floppy disk drive 124, and a flash drive memory 126. The format of the ports connected to I/O interface 116 may be any known to those skilled in the art of computer architecture, including but not limited to Universal Serial Bus (USB) ports.

Data processing system 102 is able to communicate with a software deploying server 150 via a network 128 using a network interface 130, which is coupled to system bus 106. Network 128 may be an external network such as the Internet, or an internal network such as an Ethernet or a Virtual Private Network (VPN). Software deploying server 150 may utilize a similar architecture design as that described for data processing system 102.

A hard drive interface 132 is also coupled to system bus 106. Hard drive interface 132 interfaces with hard drive 134. In an illustrative embodiment, hard drive 134 populates a system memory 136, which is also coupled to system bus 106. Data that populates system memory 136 includes an operating system (OS) 138 of data processing system 102 and application programs 144 (e.g., dependency resolver 148).

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., data processing system 102) to send and receive network messages to the Internet using HyperText Transfer Protocol (HTTP) messaging, thus enabling communication with software deploying server 150.

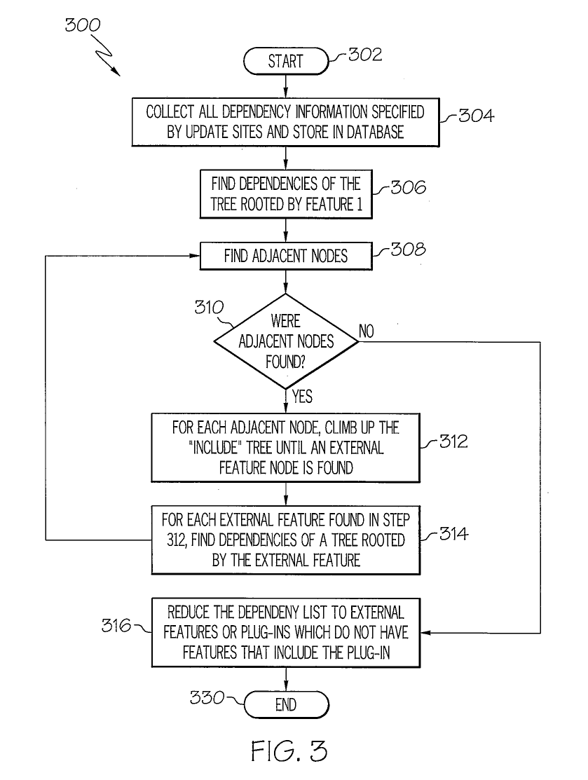

Application programs 144 in the system memory of data processing system 102 (as well as the system memory of software deploying server 150) also include an dependency resolver 148. Dependency resolver 148 comprises computer-executable code, at least a portion of which implements the method described herein with reference to FIG. 3. Dependency resolver 148 maintains database 152 and dependency list 154 which are described in further detail with reference to FIG. 3. Database 152 and dependency list 154 may reside in system memory 136, as shown, and/or may be stored in non-volatile bulk storage such as hard drive 134. In one embodiment, data processing system 102 is able to download dependency resolver 148 from software deploying server 150.

The hardware elements depicted in data processing system 102 are not intended to be exhaustive, but rather are representative to highlight essential components required by the present invention. For instance, data processing system 102 may include alternate memory storage devices such as magnetic cassettes, Digital Versatile Disks (DVDs), Bernoulli cartridges, and the like. These and other variations are intended to be within the spirit and scope of the present invention.

Note further that, in one embodiment of the present invention, software deploying server 150 performs all of the functions associated with the present invention (including execution of dependency resolver 148), thus freeing data processing system 102 from having to use its own internal computing resources to execute dependency resolver 148.

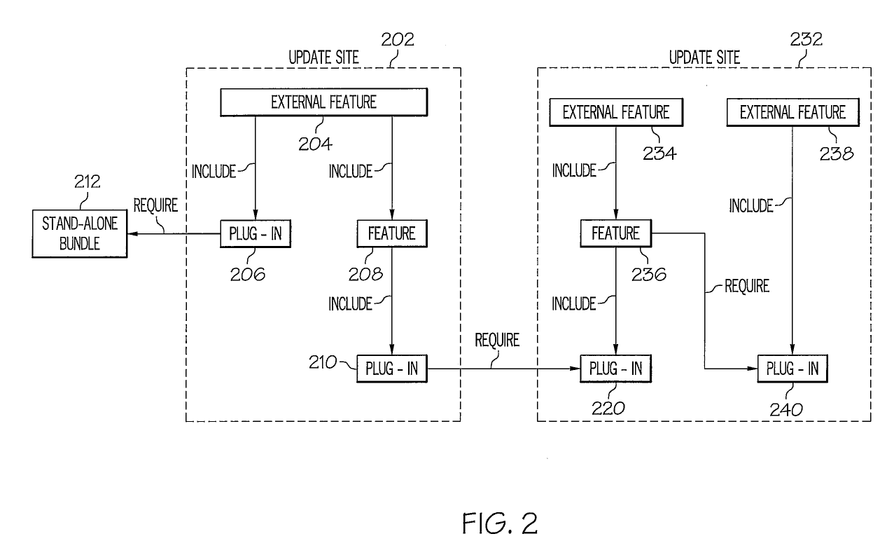

With reference now to FIG. 2, two dependency trees are shown that depict the dependencies between user-installable features and plug-ins of a rich client platform (e.g., Eclipse). Each dependency tree corresponds to features and plug-ins which are available on two different software update sites 202 and 232. The nodes of dependency trees for update sites 202 and 232 represent features and plug-ins available on each update site, while the edges connecting the nodes represent the dependencies between the nodes. Only nodes representing external features or stand-alone bundles are installable by a user. Other features and plug-ins are installed as part of the installation of another (external) feature. Each dependency tree is rooted by an external (installable) feature. A single update site can include many features and plug-ins. The dependencies of features and plug-ins are typically described using the words “include” and “require” in XML files hosted on the update site. “Include” means that a feature or plug-in is included in the installation of another feature. “Require” means that a feature or plug-in is required for the proper installation another feature, but the required feature or plug-in is not included in the installation of the dependent feature. Typically, a user must locate the required feature on another update site or in another external feature on the same update site to complete the installation.

As shown in FIG. 2, update site 202 provides an installable external feature 204. External feature 204 includes plug-in 206, feature 208 and plug-in 210 (which is included in feature 208). Plug-in 206, plug-in 210 and feature 208 are not installable by themselves, but are installed as part of the installation of external feature 204. External feature 204 also requires plug-in 220. However, plug-in 220 is not included as part of the installation of external feature 204 and is not available on update site 202. A user must locate an update site for and obtain a copy of plug-in 220 for external feature 204 to function as intended. Additionally, external feature 204 requires stand-alone bundle 212 (via plug-in 206) which is not included as part of the installation of external feature 204. A user must locate an update site for and obtain a copy of bundle 212 for external feature 204 to function as intended. Stand-alone bundle is a self-contained piece of software, such as a naked OSGi bundle, that is independently installable from external feature 204.

Update site 232 provides two installable (external) features 234 and 238. External feature 234 includes feature 236 and plug-in 220 (which is included in feature 236). Plug-in 220 and feature 236 are not installable by themselves, but are installed as part of the installation of external feature 234. External feature 204 also requires plug-in 240 (via feature 236). However, plug-in 240 is not included as part of the installation of external feature 234. Plug-in 240 is available on update site 232 as part of the installation of external feature 238, which includes plug-in 240.

With reference now to FIG. 3, a flowchart 300 is shown depicting an exemplary method for providing an enhanced dependency resolver 148 in accordance with one or more embodiments of the present invention. The method enables dependency resolver 148 to resolve feature dependencies among multiple update sites and enables a user to locate and download all required installation files to complete the installation of a particular feature of a rich client platform (e.g., Eclipse). Dependency resolver 148 starts at initiator block 302. In step 304, dependency resolver 148 collects all dependency information specified by update sites 202 and 232 in files such as site.xml, feature.xml, plugin.xml or bundle manifest files and stores the collected information in database 152. Dependency resolver 148 finds the dependencies for external feature 204 by traversing down the dependency tree rooted by external feature 204 and identifying the features and plug-ins that external feature 204 includes or requires (step 306). The identified nodes corresponding to features and plug-ins are stored in a dependency list 154 within database 152.

Once the dependencies of external feature 204 are identified, dependency resolver 148 searches for any adjacent nodes and stores the adjacent nodes in dependency list 154 (step 308). An adjacent node is a node that is required by, but not included in, a dependency tree rooted by an installable external feature, but is included in an installable external feature of another dependency tree in the database of step 305. In the example shown in FIG. 2, plug-in 220 is an adjacent node of external feature 204. Plug-in 220 is required by external feature 204, but is not included as part of the installation of external feature 204. However, plug-in 220 is available from update site 232 as part of the installation of external feature 234.

If adjacent nodes are found (step 310), dependency resolver climbs the “include” tree for each adjacent node until a node corresponding to an installable external feature is found (step 312). For each external feature found in step 312, dependency resolver 148 traverses back down to find the dependencies (step 314) and adjacent nodes (step 310) of each feature. Step 310 through step 314 are applied recursively until no more adjacent nodes are found. Once no more adjacent nodes are found in step 310, dependency resolver 148 proceeds to step 316 and reduces the nodes stored in dependency list 154 to those nodes which represent user-installable features or plug-ins (i.e., external features or stand-alone bundles). Following step 316, the process ends at terminator block 330. The nodes in dependency list 154 represent the features or plug-ins that a user must install to complete the installation of external feature 204. Using this information, the user may then manually install each feature or plug-in in dependency list 154 or, alternatively, dependency resolver may automatically install each feature or plug-in in dependency list 154.

While the present invention has been particularly shown and described with reference to an illustrative embodiment, it will be understood by those skilled in the art that various changes in form and detail may be made therein without departing from the spirit and scope of the invention. Furthermore, as used in the specification and the appended claims, the term “computer” or “computer system” or “computing device” includes any data processing system including, but not limited to, personal computers, servers, workstations, network computers, mainframe computers, routers, switches, Personal Digital Assistants (PDA's), telephones, and any other system capable of processing, transmitting, receiving, capturing and/or storing data. The term “system” or “information system” includes a network of data processing systems.

The flowchart and diagrams in the Figures illustrate the arclitecture, functionality, and operation of possible implementations of systems, methods and computer program products according to various embodiments of the present invention. In this regard, each block in the flowchart or diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to illustrative embodiments thereof, it will be apparent that modifications and variations are possible without departing from the scope of the invention defined in the appended claims.

What is claimed is:

1. A method in a data processing system comprising:
collecting dependency information for features and plug-ins of a rich client platform from a plurality of update sites;
storing the dependency information for said features and plug-ins in a database;
constructing a plurality of dependency trees using the dependency information of the database, wherein each of said plurality of dependency trees is rooted by a node representing an installable feature;
selecting a first installable feature;
identifying all nodes of a dependency tree rooted by the first installable feature;
determining which of said nodes require an adjacent node;
in response to determining that a node requires an adjacent node, climbing the include tree of the adjacent node until a node of a second installable feature is found; and
in response to finding the node of the second installable feature, recording in said database that the second installable feature is required for the installation of the first installable feature.

2. The method of claim 1, wherein said method is applied until no more adjacent nodes are identified.

3. A system comprising:
means for collecting dependency information for features and plug-ins of a rich client platform from a plurality of update sites;
means for storing the dependency information for said features and plug-ins in a database;
means for constructing a plurality of dependency trees using the dependency information of the database, wherein each of said plurality of dependency trees is rooted by a node representing an installable feature;
means for selecting a first installable feature;
means for identifying all nodes of a dependency tree rooted by the first installable feature;
means for determining which of said nodes require an adjacent node;
means, responsive to determining that a node requires an adjacent node, for climbing the include tree of the adjacent node until a node of a second installable feature is found; and
means, responsive to finding the node of the second installable feature, for recording in said database that the second installable feature is required for the installation of the first installable feature.

4. The system of claim 3, wherein said system is utilized until no more adjacent nodes are identified.

5. A computer-readable medium encoded with a computer program product that, when executed, performs the steps of:
collecting dependency information for features and plug-ins of a rich client platform from a plurality of update sites;
storing the dependency information for said features and plug-ins in a database;
constructing a plurality of dependency trees using the dependency information of the database, wherein each of said plurality of dependency trees is rooted by a node representing an installable feature;
selecting a first installable feature;
identifying all nodes of a dependency tree rooted by the first installable feature;
determining which of said nodes require an adjacent node;
in response to determining that a node requires an adjacent node, climbing the include tree of the adjacent node until a node of a second installable feature is found; and
in response to finding the node of the second installable feature, recording in said database that the second installable feature is required for the installation of the first installable feature.

6. The computer-readable medium of claim 5, wherein said computer program product encoded therein is executed until no more adjacent nodes are identified.
